(19) United States
(12) Patent Application Publication
(10) Pub. No.: US 2010/0073563 A1
(43) Pub. Date: Mar. 25, 2010

(54) METHOD AND APPARATUS FOR CONTROLLING AN ELECTRICAL DEVICE

(76) Inventors: Christopher Painter, Pleasanton, CA (US); Arthur Stanley Brigham, Sunnyvale, CA (US); Alla Shapiro, Mountain View, CA (US)

Correspondence Address: PILLSBURY WINTHROP SHAW PITTMAN LLP, P.O. BOX 10500, MCLEAN, VA, 22102, US

(21) Appl. No.: 12/559,368

(22) Filed: Sep. 14, 2009

Related U.S. Application Data
(60) Provisional application No. 61/096,723, filed on Sep. 12, 2008.

(51) Int. Cl. H04N 5/445; H04N 5/44; G06F 3/041; G06F 3/033; G06F 3/048

(52) U.S. Cl. 348/563; 348/734; 345/173; 345/160; 715/786; 348/E05.103; 348/E05.1

(57) ABSTRACT

An apparatus for controlling an electrical device, the apparatus comprising: a touch module for sensing user input and generating a touch signal and a press signal; at least one switch assembly for accepting the press signal and generating a selection signal; and a processing module for receiving the touch signal and the selection signal and for generating a processed signal for controlling the electrical device, the processed signal comprising at least one television control signal.

### CROSS-REFERENCE TO RELATED APPLICATIONS

This application claims the benefit of the filing date of the provisional application titled, “User Interface Device and Methodology”; Christopher Painter, inventor; attorney docket number 31811-373380 (GLTV-001-P); the entire contents and appendices of which are hereby included by reference.

### BACKGROUND

The present invention relates generally to the field of remote controls for electrical devices and more specifically to the field of remotely controlling electrical devices using a touch-operable input device.

In a wide variety of applications, remote controls provide their users with remote access to the functions of various electrical devices, such as, for example, media players, televisions, medical devices, robots, or video game controllers.

Largely, conventional remote controls use an array of dedicated, mechanical push buttons to access these functions. Mechanical push buttons provide two desirable qualities: “absolute location functionality”—being fixed in function and fixed at an absolute location on the remote control—enabling the user to easily find a given function; and, “in-place selectability”—allowing the given function, once found at an absolute location, to be selected simply by pressing at that same absolute location. Unfortunately, owing to the size of mechanical push buttons, such conventional remote controls suffer from a relatively low functional density. As the number of electrical device functions grows, the size of these conventional remote controls grows to the point of becoming uncomfortable and unwieldy.

Replacing some or all of a conventional remote control's mechanical push buttons with a touchpad—a touch-operable input device as often incorporated in laptop computers—offers the promise of relatively higher functional density. Additionally, curving the touchpad surface packs more surface area into the same footprint to achieve even higher functional density. However, if the touchpad were to be operated in a conventional, relative motion mode, as is typically done in laptop computers, the desirable qualities of absolute location functionality and in-place selectability would be lost.

Fortunately, by operating the touch pad in an unconventional, absolute motion mode, absolute location functionality can be restored. Furthermore, by operably coupling the touchpad with a switch assembly, so that pressing the touchpad operates one or more selection switches, in-place selectability can also be restored.

Opportunities exist, therefore, to provide an improved remote control with the same desirable qualities as a conventional remote control, and with increased functional density, by incorporating a touchpad, operating in absolute mode, operably coupled to a switch assembly.

### SUMMARY

The opportunities described above are addressed, in one embodiment of the present invention, by an apparatus for controlling an electrical device, the apparatus comprising: a touch module for sensing user input and generating a touch signal and a press signal; at least one switch assembly for accepting the press signal and generating a selection signal; and a processing module for receiving the touch signal and the selection signal and for generating a processed signal for controlling the electrical device.

In one embodiment of the apparatus, the processed signal comprises at least one television control signal.

In another embodiment of the apparatus, the processed signal comprises absolute location data corresponding to spatial locations of the touch module.

In still another embodiment of the apparatus, the touch module comprises a concave touch surface disposed and configured for sensing the user input.

The present invention is also embodied by a method for controlling an electrical device, the method comprising the acts of: sensing user input using a touch module: generating a touch signal or a press signal from the user input; generating a selection signal from the press signal using at least one switch assembly; and generating a processed signal from the touch signal and the selection signal for controlling the electrical device.

In one embodiment of the method, the processed signal comprises at least one television control signal.

In another embodiment of the method, the processed signal comprises absolute location data corresponding to spatial locations of the touch module.

In still another embodiment of the method, the touch module comprises a concave touch surface disposed and configured for sensing the user input.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an apparatus for controlling an electrical device in accordance with one embodiment of the present invention.

FIG. 2 illustrates one view of an orthographic drawing of a more detailed embodiment in accordance with the embodiment of FIG. 1.

FIG. 3 illustrates an alternative embodiment to the embodiment of FIG. 2.

FIG. 4 illustrates top and front views of an orthographic drawing of another more detailed embodiment in accordance with the embodiment of FIG. 1.

### DETAILED DESCRIPTION

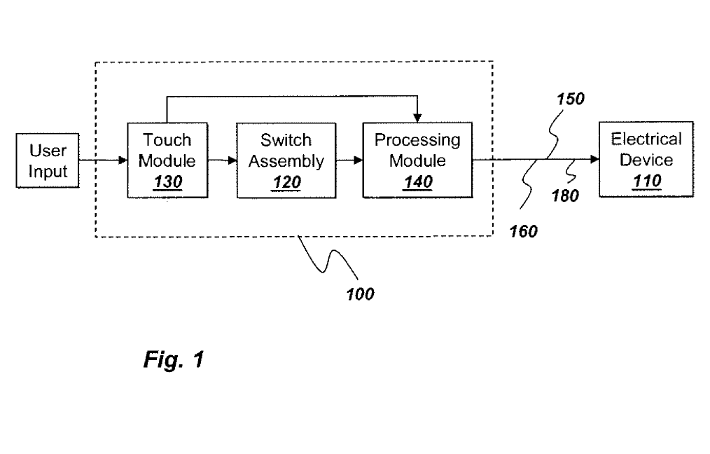

In accordance with an embodiment of the present invention, FIG. 1 is a block diagram illustrating an apparatus 100 for controlling an electrical device 110. Apparatus 100 comprises a touch module 130, at least one switch assembly 120, and a processing module 140. In operation, touch module 130 senses a user input and generates a touch signal and a press signal. Switch assembly 120 accepts the press signal and generates a selection signal. Processing module 140 receives the touch signal and the selection signal and generates a processed signal 150 for controlling electrical device 110.

Electrical device 110 refers to any electrically powered device, assembly, or combination thereof, operable by a user. Examples of electrical device 110 include, without limitation, media players, televisions, medical devices, robots, and video game controllers.

As used herein, the term “finger” refers to any of the five terminating members of the hand including the thumb. “User input” refers to two types of physical interaction with touch module 130 typically performed with one or more fingers: a “touch input,” referring to establishing a sufficiently close proximity to, or exerting a light pressure on touch module 130; and a “press input,” referring to exerting a heavier pressure on touch module 130.

Touch module 130 refers to any device, assembly, or combination thereof capable of sensing the user input, for example by optical, mechanical, or electrical means, and generating a touch signal in response to a touch input, and a press signal in response to a press input. The touch signal typically comprises coordinate information identifying a location on touch module 130 and is embodied in any manner compatible with processing module 140. In example embodiments of the invention, touch module 130 incorporates a capacitive touch sensor such as a TM3957 Touchpad manufactured by Cirque Corporation of Salt Lake City, Utah, which produces a touch signal having coordinate information suitable for use in the invention. Those skilled in the art will understand how to incorporate various other additional or alternative touch module devices after being taught by this example. The press signal is a binary signal, embodied in any manner compatible with switch assembly 120.

Switch assembly 120 refers to any device, assembly, or combination thereof, for example, mechanical, optical, or electrical, capable of receiving the press signal and generating the selection signal. The selection signal is a binary signal embodied in any manner compatible with processing module 140.

Processing module 140 refers to any device, assembly, or combination thereof capable of receiving the touch signal and the selection signal, however embodied, and generating processed signal 150, embodied in a form compatible with electrical device 110.

In typical embodiments, the touch signal and the selection signal are embodied as conducted electrical signals; the press signal as a mechanical signal, for example, a force or a displacement; and processed signal 150 as an electromagnetic wave signal, for example, a radio frequency wave or infrared wave.

In a more detailed embodiment in accordance with the embodiment of FIG. 1, electrical device 110 is a television and processed signal 150 comprises at least one television control signal 160. Television control signal 160 is an electromagnetic wave signal encoded with a remote control protocol, for example, RC4 and RC5, commonly used to control televisions, VCRs, DVD players, and stereos. In some embodiments television control signal 160 also includes, without limitation, encoded display menus, typically encoded using NTSC or PAL television standards.

Typical control signals of television control signal 160 include, without limitation, power on, power off, search, home, volume up, volume down, keypad mode, cursor mode, fast forward, play, pause, rewind, mute, text mode, numerical mode, and combinations thereof. The control signals “power on” and “power off” control the power to electrical device 110; “volume up,” “volume down,” and “mute,” control the intensity of the sound from electrical device 110; “fast forward,” “play,” “pause,” and “rewind” control playback or display of sequential media, such as, without limitation, films, albums, books on tape, and video games; “search” activates a search function on electrical device 110; “home” activates a function on electrical device 110 restoring a set of default values; “keypad mode,” “cursor mode,” “text mode,” and “numerical mode” are different modes for apparatus 100 to interact with electrical device 110.

In another more detailed embodiment in accordance with the embodiment of FIG. 1, processed signal 150 comprises absolute location data 180 corresponding to a spatial location on apparatus 100.

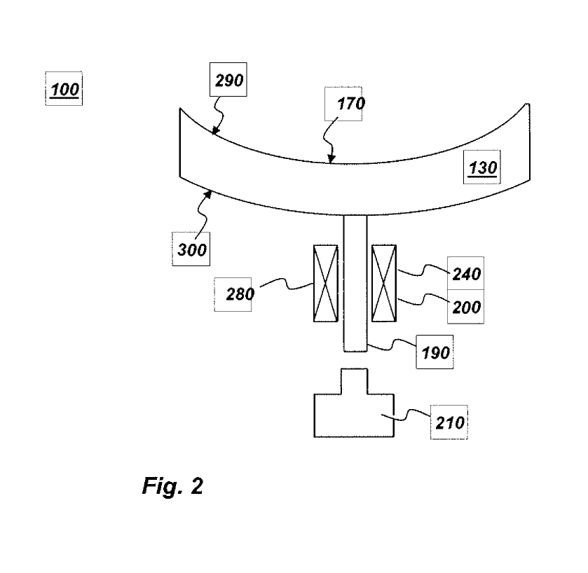

In accordance with another more detailed embodiment of the embodiment of FIG. 1, FIG. 2 illustrates one view of an orthographic drawing wherein apparatus 100 comprises a concave touch surface 170, a shaft 190, a bearing 200, and a selection switch 210. Concave touch surface 170 provides the user with more surface area in the same footprint than conventional flat touch surfaces. In some embodiments, the shape of concave touch surface 170 nearly conforms to the natural arc of motion of a finger.

Shaft 190 is a mechanical component, mechanically coupled to the concave touch surface 170 to generate a mechanical operating signal when a press signal is received. Shaft 190 is supported and guided by bearing 200.

Bearing 200 supports the structure of apparatus 100 when a press input is received anywhere on concave touch surface 170. Bearing 200 may be embodied, without limitation, as a magnetic bearing, air bearing, hydrostatic bearing, hydrodynamic bearing, cylindrical roller bearing, ball bearing, angular contact bearing, linear bearing or jewel bearing.

Bearing 200 is typically embodied as a linear bearing 280, specifically an anti-rotation circulating ball bearing 240.

In some embodiments, a guide shaft 250 guides the motion of touch module 130 when a press signal has been received. Guide shaft 250 refers to any mechanical component capable of performing the indicated function.

In a more detailed embodiment in accordance with the apparatus embodiment of FIG. 1, a method of controlling electrical device 110 begins with displaying a primary menu on a display of electrical device 110. Using a finger, the user provides a first touch input to touch module 130. In response to the first touch input, a primary menu item is highlighted on the primary menu. The user then increases the pressure of the finger to provide a first press input. By holding the first press input for a time greater than a prescribed time interval an extended press input is provided. In response to the extended press input, a secondary menu is displayed. The user then decreases the pressure to provide a second touch input without losing contact with touch module 130. Moving the finger, without losing contact with the touch module 130, to a location corresponding to a secondary menu item causes the secondary menu item to be highlighted. Then, increasing the pressure again provides a second press input. This time, holding the second press input for a time less than the prescribed time interval, and reducing the pressure to provide a third touch input, causes a function, corresponding to the secondary menu item, to be executed. When the third touch input is finally removed, the secondary menu is hidden.

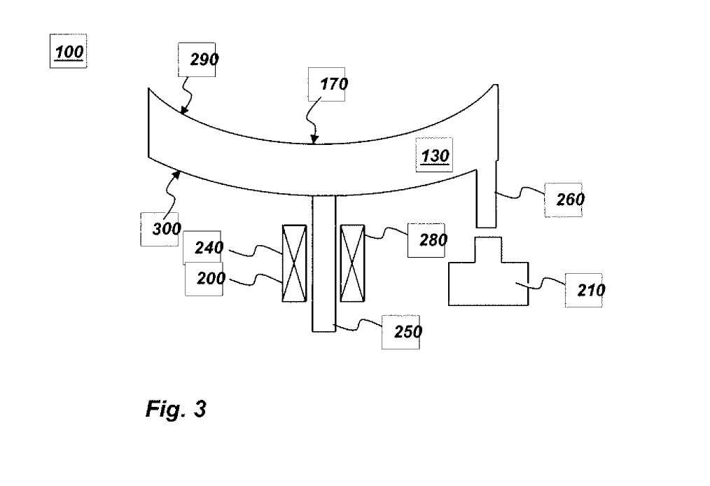

In an alternative embodiment to the embodiment of FIG. 2, FIG. 3 illustrates an orthographic drawing wherein a mechanical operator 260 is used to transmit the mechanical operating signal. Mechanical operator 260 refers to any mechanical component capable of generating the mechanical operating signal.

Selection switch 210 is any switch capable of receiving the mechanical operating signal and generating a selection signal. For example, selection switch 210 may be embodied, without limitation, as a tactile switch, fiber optic switch, pressure switch, magnetic switch or a resistive switch. Selection signal is any signal compatible with processing module 140. The selection signal is typically embodied as a conducted electrical signal.

FIG. 3 also illustrates an upper surface 290 and a lower surface 300 of the concave touch surface 170. Upper surface 290 refers to a surface with two radii of curvature, each less than about 20 inches, creating a bowl-like shape. Typically the radii of curvature of upper surface 290 are each about 5 inches. Upper surface 290 is typically presented to the user for user inputs. Lower surface 300 refers to a surface with only one radius of curvature, less than about 20 inches and typically about 5 inches.

Having only one radius of curvature on lower surface 300 reduces manufacturing costs while having surprisingly little impact on the generation of touch from touch module 130 and selection signals from at least one switch assembly 120.

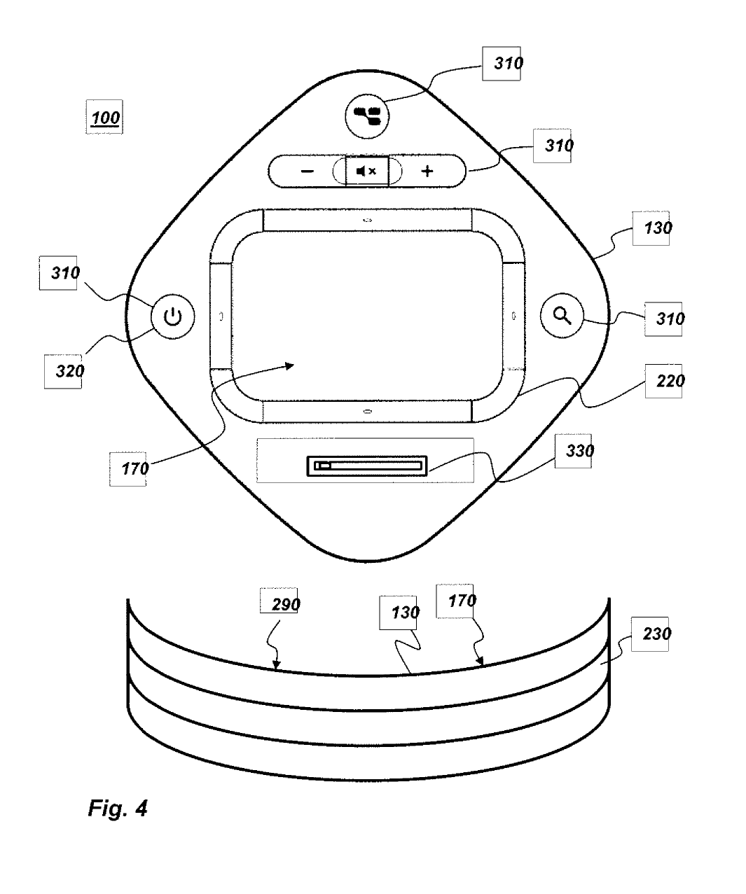

The top diagram of FIG. 4 illustrates an embodiment of the present invention, showing dedicated device button 310, pushbutton switch 320, slide potentiometer 330, and operating indicia 220. The bottom diagram of FIG. 4 illustrates a cross sectional view of an embodiment further comprising lighting assembly 230.

Dedicated device button 310 refers to any device capable of sensing user input and generating a dedicated device button signal compatible with processing module 140. Dedicated device button 310 may be embodied, without limitation, as a pushbutton switch, dome switch, rocker switch, magnetic switch, optical switch, proximity switch, slide switch, or toggle switch. In a typical embodiment shown in FIG. 4, there are more than one dedicated device button 310, embodied as a pushbutton switch 320 and a slide potentiometer 330.

Pushbutton switch 320 refers to an embodiment of dedicated device button 310 wherein a press input generates a binary signal. Slide potentiometer 330 refers to an embodiment of dedicated device button 310 wherein a press input generates an analog signal.

Operating indicia 220 refers to markings explaining functionality of particular components or locations on apparatus 100. For example, a dedicated device button 310 may be labeled with operating indicia 220 indicating that a press input will toggle power to the device. Other typical operating indicia 220 include, without limitation, Power, Search, Home, Volume up, Volume down, Keypad/Cursor mode, Fast Forward, Play, Pause, Rewind, Mute, and Text/Numerical mode.

Operating indicia 220 further label dedicated areas of concave touch surface 170. In typical embodiments of concave touch surface 170, concave touch surface 170 is a polygon wherein the edges and corners are labeled with operating indicia 220 indicating special functionality in those locations. For example, operating indicia 220 may be used to indicate an area near an edge of concave touch surface 170 dedicated to a scrollbar selection function.

In a more detailed embodiment in accordance with the embodiment of FIG. 4, the scrollbar selection function displays two cursors: a category cursor and an item cursor. The display locations of the category cursor and the item cursor correspond to one of a plurality of data categories and one of a plurality of data items, respectively. Touch inputs are used to move the category cursor and a corresponding category label is highlighted as the cursor nears the category label. In response to a press input, the item cursor is moved and the graphical content corresponding to the new item cursor display location is displayed. When all touch inputs are removed, all category labels are hidden. Examples of data items include, without limitation, one or more stored movies, television shows, songs, photographs, or combinations thereof. Examples of data categories include, without limitation, genre (e.g., mystery, horror, action, etc.), running time, MPAA rating, user rating, decade (e.g., 40s, 50s, 60s, etc.), production studio, director, actor.

In some embodiments, as illustrated in FIG. 4, the operating indicia 220 are substantially transparent, and illuminated by lighting assembly 230. Lighting assembly 230 refers to all the optical, mechanical, and electrical components necessary for providing illumination, for example, light shaping components, mounts, and light sources. Examples of light sources for lighting assembly 230 include, without limitation, light emitting diodes, incandescent lamps, fluorescent lamps, plasma sources, and lasers. Light shaping components include, without limitation, diffusers, lenses, prisms, and mirrors.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for controlling an electrical device, said apparatus comprising:
a touch module for sensing user input and generating a touch signal and a press signal;
at least one switch assembly for accepting said press signal and generating a selection signal; and
a processing module for receiving said touch signal and said selection signal and for generating a processed signal for controlling said electrical device,
said processed signal comprising at least one television control signal.

2. An apparatus for controlling an electrical device, said apparatus comprising:
a touch module for sensing user input and generating a touch signal and a press signal;
at least one switch assembly for accepting said press signal and generating a selection signal; and
a processing module for receiving said touch signal and said selection signal and for generating a processed signal for controlling said electrical device,
said processed signal comprising absolute location data corresponding to spatial locations of said apparatus.

3. An apparatus for controlling an electrical device, said apparatus comprising:
a touch module for sensing user input and generating a touch signal and a press signal;
at least one switch assembly for accepting said press signal and generating a selection signal; and
a processing module for receiving said touch signal and said selection signal and for generating a processed signal for controlling said electrical device,
said touch module comprising a concave touch surface disposed and configured for sensing said user input.

4. The apparatus of claim 3 wherein said processed signal comprises at least one television control signal.

5. The apparatus of claim 4 wherein said at least one television control signal actuates a function of said electrical device selected from a group consisting of: power on, power off, search, home, volume up, volume down, keypad mode, cursor mode, fast forward, play, pause, rewind, mute, text mode, numerical mode, and combinations thereof.

6. The apparatus of claim 3 wherein said processed signal comprises absolute location data corresponding to spatial locations of said apparatus.

7. The apparatus of claim 3 wherein
said press signal is a mechanical operating signal,
said touch module further comprises a shaft, mechanically coupled to said concave touch surface, configured and disposed for generating said mechanical operating signal, and
said switch assembly comprises:
a bearing disposed around said shaft for supporting and guiding said shaft; and
a selection switch configured for generating said selection signal in response to said mechanical operating signal.

8. The apparatus of claim 3 wherein
said press signal is a mechanical operating signal,
said touch module further comprises:
a guide shaft mechanically coupled to said concave touch surface; and
a mechanical operator configured and disposed for generating said mechanical operating signal, and
said switch assembly comprises:
a bearing disposed around said guide shaft for supporting and guiding said guide shaft; and
a selection switch configured for generating said selection signal in response to said mechanical operating signal.

9. The apparatus of claim 8 wherein said bearing is a linear bearing.

10. The apparatus of claim 9 wherein said linear bearing is an anti-rotation circulating ball bearing.

11. The apparatus of claim 3 wherein said concave touch surface comprises operating indicia.

12. The apparatus of claim 11 wherein said concave touch surface is substantially opaque, said operating indicia are substantially transparent, and said touch module further comprises lighting assembly disposed and configured for illuminating said operating indicia.

13. The apparatus of claim 3 wherein said concave touch surface comprises an upper surface characterized by two radii of curvature.

14. The apparatus of claim 13 wherein each of said two radii of curvature is less than about 20 inches.

15. The apparatus of claim 13 wherein each of said two radii of curvature is about 5 inches.

16. The apparatus of claim 3 wherein said concave touch surface comprises a lower surface characterized by a single radius of curvature.

17. The apparatus of claim 16 wherein said single radius of curvature is less than about 20 inches.

18. The apparatus of claim 16 wherein said single radius of curvature is about 5 inches.

19. The apparatus of claim 3 wherein said touch module further comprises a dedicated device button, disposed adjacent to said concave touch surface, for sensing user input and for generating a dedicated device button signal, said processing module being further configured for receiving said dedicated device button signal and generating said processed signal based on said dedicated device button signal.

20. The apparatus of claim 19 wherein said dedicated device button signal actuates a search function in said electrical device.

21. The apparatus of claim 19 wherein said dedicated device button is a pushbutton switch.

22. The apparatus of claim 19 wherein said dedicated device button is a slide potentiometer.

23. The apparatus of claim 3 wherein said concave touch surface has the shape of a polygon having edges and corners.

24. The apparatus of claim 23 wherein said polygon is a rectangle.

25. The apparatus of claim 23 wherein said touch signal corresponding to one of said corners is configured for actuating a cursor home function of said electrical device.

26. The apparatus of claim 23 wherein said touch signal corresponding to one of said corners is configured for actuating a search function of said electrical device.

27. The apparatus of claim 23 wherein said touch signal corresponding to one of said edges is configured for actuating a menu selection function of said electrical device.

28. The apparatus of claim 23 wherein said touch signal corresponding to one of said edges is configured for actuating a scrollbar selection function of said electrical device.

29. The apparatus of claim 28 wherein said scrollbar selection function comprises the acts of:
displaying a category cursor on a display of said electrical device, the display location of said category cursor corresponding to one of a plurality of data categories;
displaying an item cursor on a display of said electrical device, the display location of said item cursor corresponding to one of a plurality of data items;
moving said category cursor in response to a touch input;
highlighting a category label corresponding to said display location of said category cursor;
moving said item cursor in response to a press input;
hiding said category label in response to removal of said touch input.

30. A method for controlling an electrical device, said method comprising the acts of:
sensing user input using a touch module;
generating a touch signal or a press signal from said user input;
generating a selection signal from said press signal using at least one switch assembly; and
generating a processed signal from said touch signal and said selection signal for controlling said electrical device,
said processed signal comprising at least one television control signal.

31. A method for controlling an electrical device, said method comprising the acts of:
sensing user input using a touch module;
generating a touch signal or a press signal from said user input;
generating a selection signal from said press signal using at least one switch assembly; and
generating a processed signal from said touch signal and said selection signal for controlling said electrical device,
said processed signal comprising absolute location data corresponding to spatial locations of said apparatus.

32. A method for controlling an electrical device, said method comprising the acts of:
sensing user input using a touch module;
generating a touch signal or a press signal from said user input;
generating a selection signal from said press signal using at least one switch assembly; and
generating a processed signal from said touch signal and said selection signal for controlling said electrical device,
said touch module comprising a concave touch surface disposed and configured for sensing said user input.

33. The method of claim 32 wherein said processed signal comprises absolute location data corresponding to spatial locations of said apparatus.

34. The method of claim 32 wherein said processed signal comprises at least one television control signal.

35. The method of claim 34 wherein said at least one television control signal actuates a function of said electrical device selected from a group consisting of: power on, power off, search, home, volume up, volume down, keypad mode, cursor mode, fast forward, play, pause, rewind, mute, text mode, numerical mode, and combinations thereof.

36. The method of claim 32 wherein
said press signal is a mechanical operating signal,
said touch module further comprises a shaft, mechanically coupled to said concave touch surface, configured and disposed for generating said mechanical operating signal, and
said switch assembly comprises:
a bearing disposed around said shaft for supporting and guiding said shaft; and
a selection switch configured for generating said selection signal in response to said mechanical operating signal.

37. The method of claim 32 wherein
said press signal is a mechanical operating signal,
said touch module further comprises:
a guide shaft mechanically coupled to said concave touch surface; and
a mechanical operator configured and disposed for generating said mechanical operating signal, and
said switch assembly comprises:
a bearing disposed around said guide shaft for supporting and guiding said guide shaft; and
a selection switch configured for generating said selection signal in response to said mechanical operating signal.

38. The method of claim 37 wherein said bearing is a linear bearing.

39. The method of claim 38 wherein said linear bearing is an anti-rotation circulating ball bearing.

40. The method of claim 32 wherein said concave touch surface comprises operating indicia.

41. The method of claim 40 wherein said concave touch surface is substantially opaque, said operating indicia are substantially transparent, and said touch module further comprises lighting assembly disposed and configured for illuminating said operating indicia.

42. The method of claim 32 wherein said concave touch surface comprises an upper surface characterized by two radii of curvature.

43. The method of claim 42 wherein each of said two radii of curvature is less than about 20 inches.

44. The method of claim 42 wherein each of said two radii of curvature is about 5 inches.

45. The method of claim 32 wherein said concave touch surface comprises a lower surface characterized by a single radius of curvature.

46. The method of claim 45 wherein said single radius of curvature is less than about 20 inches.

47. The method of claim 45 wherein said single radius of curvature is about 5 inches.

48. The method of claim 32 wherein said touch module further comprises a dedicated device button, disposed adjacent to said concave touch surface, for sensing user input and for generating a dedicated device button signal, said processing module being further configured for receiving said dedicated device button signal and generating said processed signal based on said dedicated device button signal.

49. The method of claim 48 wherein said dedicated device button signal actuates a search function in said electrical device.

50. The method of claim 48 wherein said dedicated device button is a pushbutton switch.

51. The method of claim 48 wherein said dedicated device button is a slide potentiometer.

52. The method of claim 32 wherein said concave touch surface has the shape of a polygon having edges and corners.

53. The method of claim 52 wherein said polygon is a rectangle.

54. The method of claim 52 wherein said touch signal corresponding to one of said corners is configured for actuating a cursor home function of said electrical device.

55. The method of claim 52 wherein said touch signal corresponding to one of said corners is configured for actuating a search function of said electrical device.

56. The method of claim 52 wherein said touch signal corresponding to one of said edges is configured for actuating a menu selection function of said electrical device.

57. The method of claim 52 wherein said touch signal corresponding to one of said edges is configured for actuating a scrollbar selection function of said electrical device.

58. The method of claim 57 wherein said scrollbar selection function comprises the acts of:
displaying a category cursor on a display of said electrical device, the display location of said category cursor corresponding to one of a plurality of data categories;
displaying an item cursor on a display of said electrical device, the display location of said item cursor corresponding to one of a plurality of data items;
moving said category cursor in response to a touch input;
highlighting a category label corresponding to said display location of said category cursor;
moving said item cursor in response to a press input;
hiding said category label in response to removal of said touch input.

59. The method of claim 32 further comprising the acts of:
displaying a primary menu on a display of said electrical device;
providing a first touch input to touch module using a finger;
highlighting a primary menu item on said primary menu in response to said first touch input;
increasing a pressure of said finger to provide a first press input;
holding said first press input for a time greater than a prescribed time interval to provide an extended press input;
displaying a secondary menu on said display in response to said extended press input;
decreasing said pressure to provide a second touch input without losing contact with said touch module;
moving said finger, without losing contact with said touch module, to a location, on said touch module, corresponding to a secondary menu item;
highlighting said secondary menu item;
increasing said pressure to provide a second press input;
holding said second press input for a time less than said prescribed time interval;
reducing said pressure to provide a third touch input;
executing a function, corresponding to said secondary menu item, in response to said third touch input;
removing said third touch input;
hiding said secondary menu in response to said third touch input having been removed.
